(19) United States
(12) Patent Application Publication
(10) Pub. No.: US 2017/0125985 A1
(43) Pub. Date: May 4, 2017

(54) CUTTING STRUCTURES OF WIRE STRIPPER

(71) Applicant: Chao-Chin YEN, New Taipei City (TW)

(72) Inventor: Chao-Chin YEN, New Taipei City (TW)

(21) Appl. No.: 15/001,550

(22) Filed: Jan. 20, 2016

(30) Foreign Application Priority Data
Oct. 30, 2015 (TW) 104217383

(51) Int. Cl. H02G 1/12; H02G 1/00

(52) U.S. Cl. CPC H02G 1/1212; H02G 1/005

(57) ABSTRACT

A wire stripper includes a first plier (10), a second plier (20), a blade set (30), and a first spring (40). The first plier (10) includes a first clamping handle (11) and a first clamping seat (12). The second plier (20) includes a second clamping handle (21) and a second clamping seat (22). The blade set (30) includes a first blade (31) and a second blade (32) connected to opposite sides of the first clamping handle (11) and the second clamping handle (21) correspondingly. Two ends of the first spring (40) are fixed on the first clamping handle (11) and the second clamping handle (21) respectively; the blade set (30) can perform a cutting motion through a clamping operation of the first clamping handle (11) and the second clamping handle (21) by a resilience force of the first spring (40).

### BACKGROUND OF THE INVENTION

Field of the Invention

The present invention generally relates to a hand tool and, in particular to cutting structures of wire strippers.

Description of Prior Art

A wire stripper is one of the necessary hand tools during telecommunication maintenance and electricians works. The wire stripper is used to remove outer insulation of coaxial cables, or wires and expose inner leads of the wires for facilitating an appropriate electrical connection.

In traditional wire strippers, as one side of the cutters is provided with a cutting blade and the other side is provided with a cutting pad, users must apply great force to finish a cutting work, and then the cutting blade of the wire stripper will be offset so that the cutting motion cannot be performed. In addition, an incomplete cutting with a poor cut section is happened frequently, and a re-cutting procedure will affect working efficiency. Furthermore, the re-cutting procedure will shorten the length of the cable. Therefore, using strippers improperly will bring great inconvenience for users when the length of the cable is limited.

In view of the above drawbacks, the Inventor proposes the present invention based on his expert knowledge and elaborate researches in order to solve the problems of prior art.

### SUMMARY OF THE INVENTION

Accordingly, an object of the present invention is to provide cutting structures of a wire stripper that a blade set is provided for cutting easily.

In order to achieve the object mentioned above, the present invention provides cutting structures of wire stripper comprising a first plier, a second plier, a blade set and a first spring. The first plier includes a first clamping handle and a first clamping seat coupled to a side of the first clamping handle. The second plier includes a second clamping handle and a second clamping seat coupled to a side of the second clamping handle and corresponding to the first clamping seat, and the second clamping handle and the first clamping handle are hinged by a pivot. The blade set includes a first blade and a second blade connected in opposite sides of the first clamping handle and the second clamping handle correspondingly. Two ends of the first spring are fixed on the first clamping handle and the second clamping handle respectively, wherein the blade set can perform a cutting motion through a clamping operation of the first clamping handle and the second clamping handle by a resilience force of the first spring.

Another object of the present invention is to provide cutting structures of a wire stripper, in which a supporting bracket is disposed on a side of the blade set, so that a staggered blade set can be avoided when cutting.

Comparing to the prior art, the wire stripper of the present invention comprises a first blade and a second blade connected on opposite sides of the first clamping handle and the second clamping handle correspondingly. The blade set of the present invention can provide a better cutting effect with comparing to conventional wire strippers which provides only one blade in a side. Moreover, the present invention also provides a supporting bracket on a side of the blade set so that a staggered blade set can be avoided when cutting.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective exploded view of the wire stripper of the present invention;

FIG. 2 is a perspective schematic view in one side of the wire stripper of the present invention;

FIG. 3 is a perspective schematic view in another side of the wire stripper of the present invention;

FIG. 4 is a sectional view of the assembly of the wire stripper of the present invention;

FIG. 5 is a schematic view showing an operating state of the wire stripper of the present invention;

FIG. 6 is a schematic view showing another operating state of the wire stripper of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

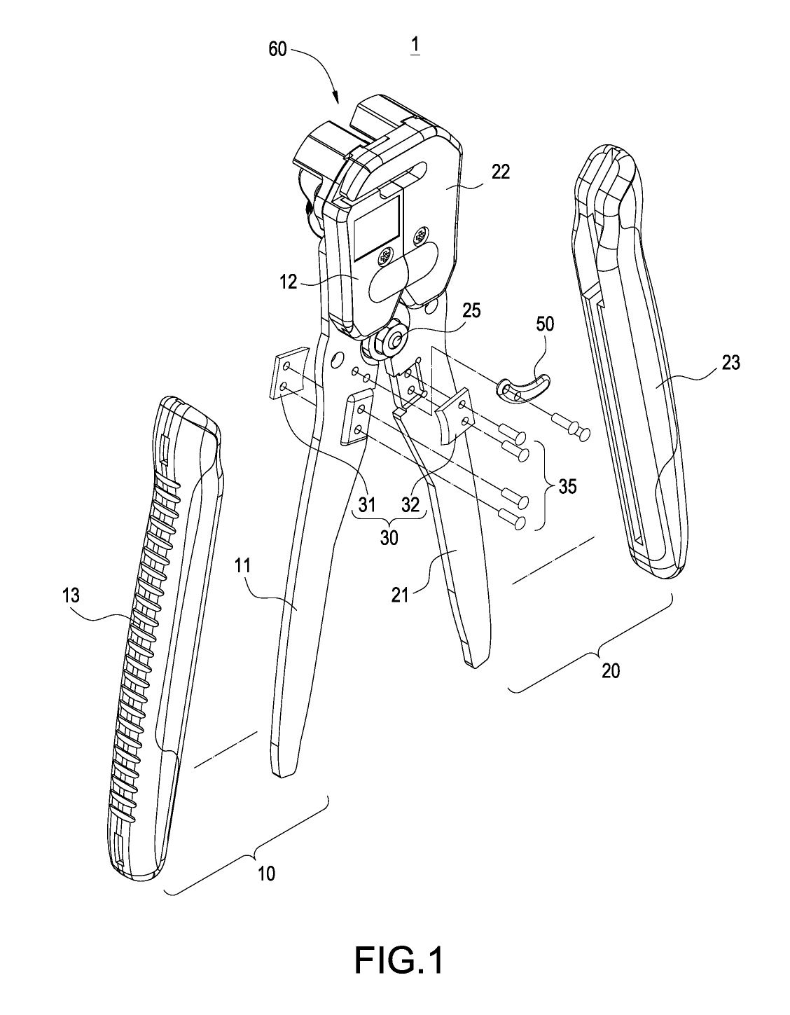

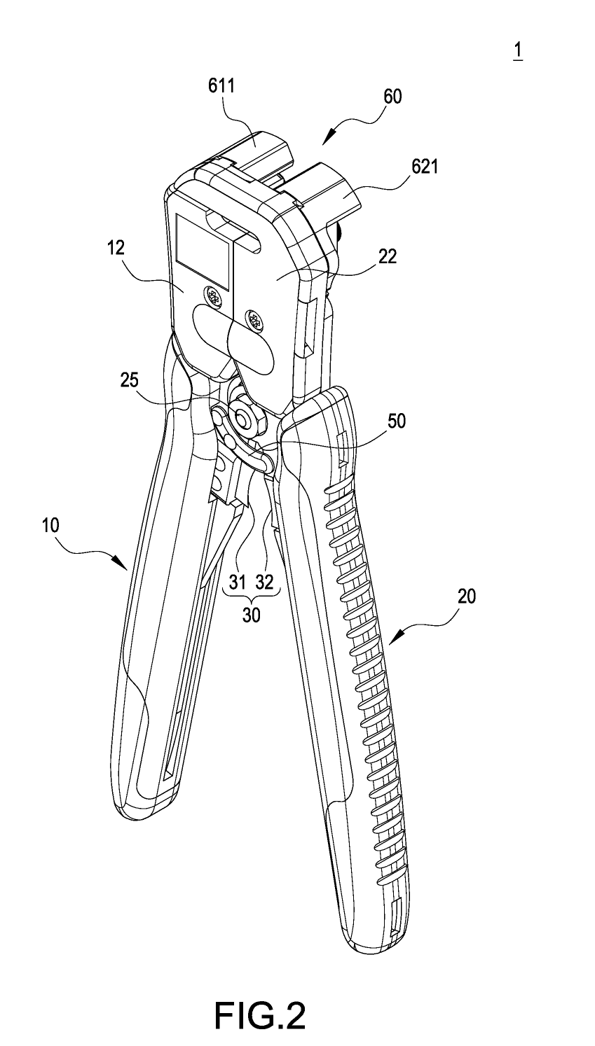

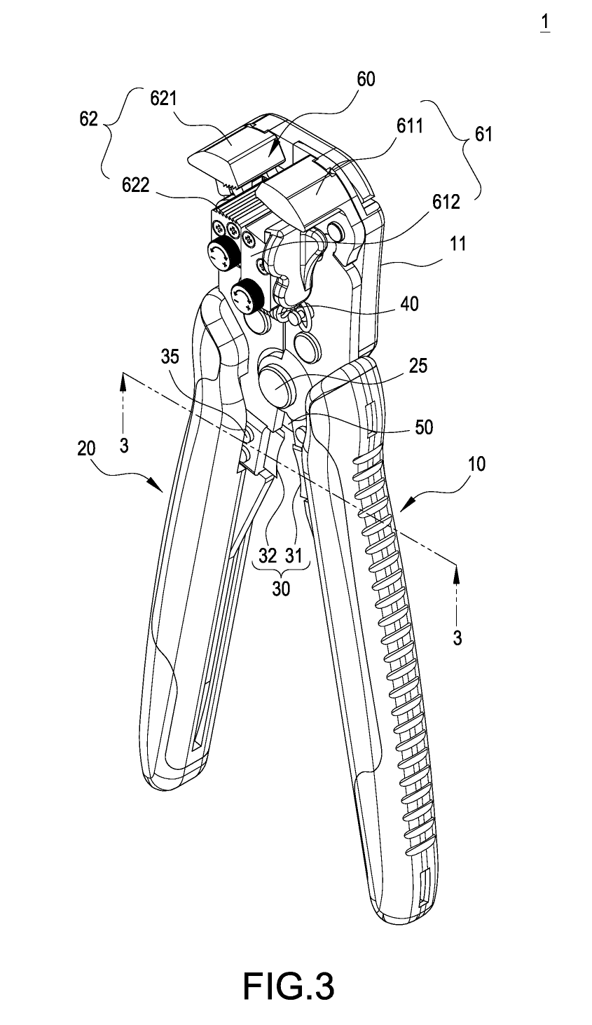

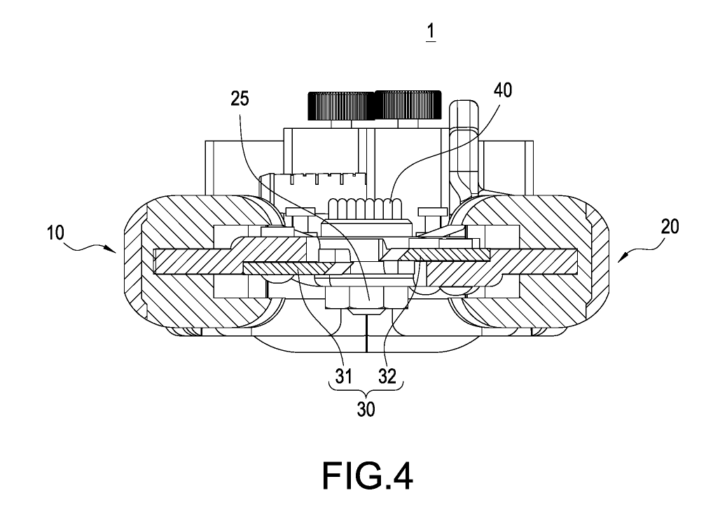

Please refer to FIG. 1 to FIG. 4, which depict a perspective schematic view, two sides of perspective schematic views and a cross sectional view of the assembly of the present invention. The present invention provides cutting structures of wire stripper comprising a first plier 10, a second plier 20, a blade set 30, a first spring 40 and a supporting bracket 50, wherein the first plier 10 and the second plier 20 are pivoted together. The blade set 30, the first spring 40 and the supporting bracket 50 are disposed between the first plier 10 and the second plier 20.

The first plier 10 includes a first clamping handle 11 and a first clamping seat 12 coupled to a side of the first clamping handle 11. Moreover, the second plier 20 includes a second clamping handle 21 and a second clamping seat 22 coupled to a side of the second clamping handle 21 and corresponding to the first clamping seat 12. The second clamping handle 21 and the first clamping handle 11 are hinged by a pivot 25.

In an embodiment of the present invention, the first plier 10 further includes a first clamping sleeve 13, and the second plier 20 further includes a second clamping sleeve 23. The first clamping sleeve 13 is sleeved on an outer of the first clamping handle 11, and the second clamping sleeve 23 is sleeved on the second clamping handle 21. The first clamping sleeve 13 and the second clamping sleeve 23 are provided for a better grip force.

The blade set 30 includes a first blade 31 and a second blade 32. The first blade 31 and the second blade 32 are connected on opposite sides of the first clamping handle 11 and the second clamping handle 21 correspondingly. Furthermore, in the present invention, the blade set 30 and the pivot 25 are close to a portion where users grip the first clamping handle 11 and the second clamping handle 21 (the first clamping sleeve 13 and the second clamping sleeve 23). Preferably, the wire stripper 1 further includes a plural of rivets 35. The blade set 30 is combined on the first clamping handle 11 and the second clamping handle 21 through the rivets 35.

Furthermore, two ends of the first spring 40 are fixed on the first clamping handle 11 and the second clamping handle 21 respectively, wherein the blade set 30 can perform a cutting motion through a clamping operation of the first clamping handle 11 and the second clamping handle 21 by a resilience force of the first spring 40.

Moreover, the supporting bracket 50 is a curved piece of body, preferably, a metal sheet. The supporting bracket 50 is disposed on a side of the blade set 30, and one end of the supporting bracket 50 is connected with the first clamping handle 11 and another end of the supporting bracket (50) is extended to the second clamping handle 21. Preferably, the supporting bracket 50 is disposed between the pivot 25 and the blade set 30. Besides, the supporting bracket 50 and the first spring 40 are provided on opposite sides of the first clamping handle 11 and the second clamping handle 21. In actual practice, half of the supporting bracket 50 is, but not limited to, connected to one side of the first clamping handle 11.

Furthermore, the supporting bracket 50 can provide a supporting force for the first clamping handle 11 and the second clamping handle 21 when the blade set performs the cutting motion, thus an offset of the first clamping handle 11 and the second clamping handle 21 caused by a pushing from an external force will be avoided.

The wire stripper 1 further includes stripping structures 60. In the present embodiment, the stripping structures 60 are provided on one end of the first clamping seat 12 and the second clamping seat 22. The stripping structures 60 include a blade seat 61 disposed on the first clamping seat 12 and a clamping set 62 disposed on the second clamping seat 22. The blade seat 61 performs a cutting work and includes a movable blade seat 611 and a fixed blade seat 612. In addition, the clamping set 62 performs a holding work and includes a movable blade seat 611 and a fixed blade seat 612. The wire stripper 1 can perform an insulation stripping of a cable by a co-operation of the blade seat 61 and the clamping set 62.

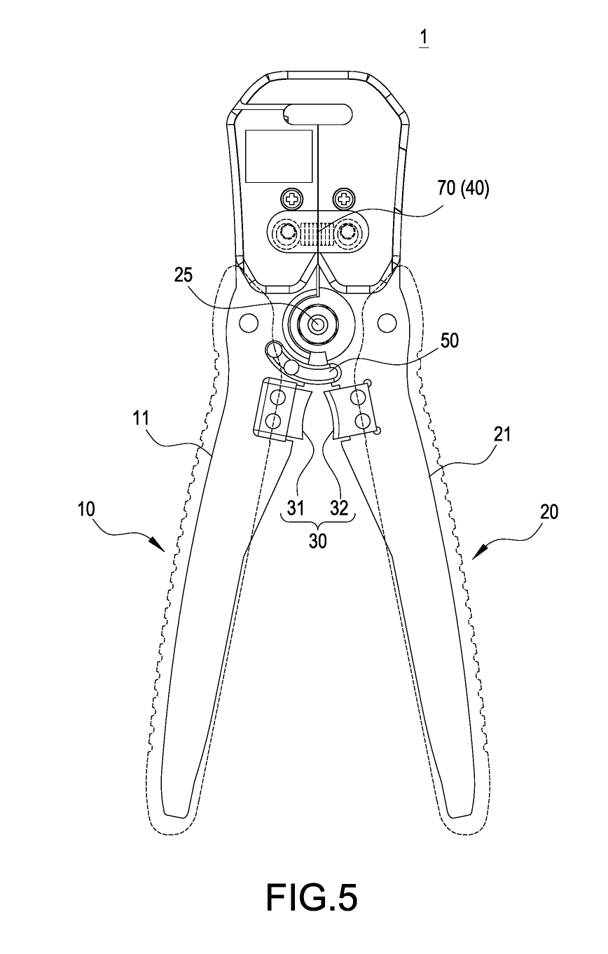

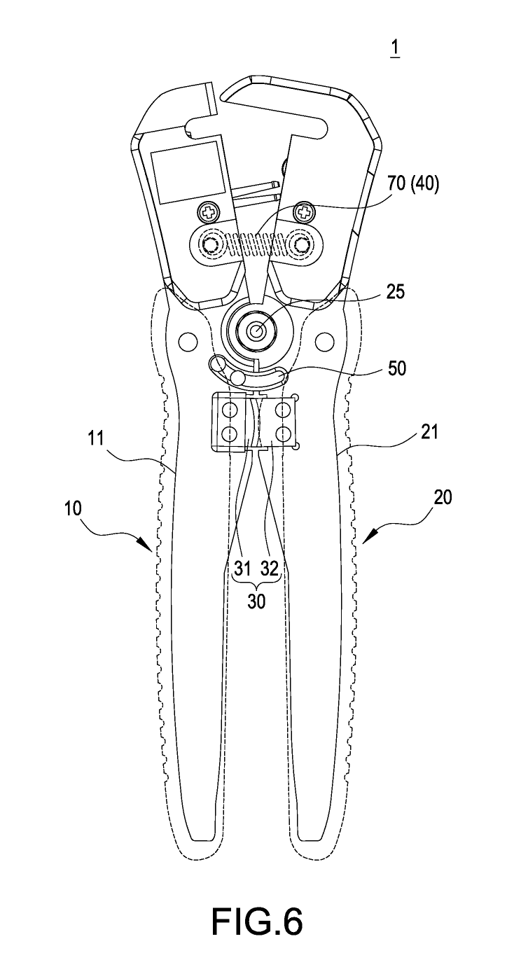

Please further refer to FIG. 5 and FIG. 6, which depict two schematic views showing operating states of the present invention. In an embodiment of the present invention, the wire stripper 1 further includes a second spring 70. The second spring 70 and the first spring 40 are provided on opposite sides of the first clamping handle 11 and the second clamping handle 21. The second spring 70 is provided to assist the first spring 40 for providing enough resilience force of the wire stripper 1.

As shown in FIG. 5, when a user does not squeeze on the first plier 10 and the second plier 20, the second spring 70 (first spring 40) is in a compressed state without an external force. Meanwhile, the first plier 10 and the second plier 20 are in an open status, and the blade set 30 is also in an open status. Thus a cable (not shown) can be placed in the blade set 30 for cutting.

As shown in FIG. 6, when a user apply forces to the first plier 10 and the second plier 20, the second spring 70 (the first spring 40) will be in a tension state by the external force. At that moment, the first plier 10 and the second plier 20 will be in a closed status. Then the blade set 30 can perform the cutting of the cable which is placed in the blade set 30.

It is worth notice that a length of the supporting bracket 50 extending over the second clamping handle 21 when the blade set 30 is in a closed status is longer than the length of the supporting bracket 50 when the blade set 30 is in an open status. That is, the supporting bracket 50 will provide more supporting force when the blade set 30 is in a closed status. Whereby an offset of the first clamping handle 11 and the second clamping handle 21 by a pushing from an external force will not be occurred, and a staggered blade set 30 can be avoided.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. Cutting structures of wire stripper, comprising:
a first plier (10) including a first clamping handle (11) and a first clamping seat (12) coupled to a side of the first clamping handle (11);
a second plier (20) including a second clamping handle (21) and a second clamping seat (22) coupled to a side of the second clamping handle (21) and corresponding to the first clamping seat (11), the second clamping handle (21) and the first clamping handle (11) being hinged by a pivot (25);
a blade set (30) including a first blade (31) and a second blade (32) connected to opposite sides of the first clamping handle (11) and the second clamping handle (21) correspondingly; and
a first spring (40), two ends of the first spring (40) being fixed on the first clamping handle (11) and the second clamping handle (21) respectively, wherein the blade set (30) can perform a cutting motion through a clamping operation of the first clamping handle (11) and the second clamping handle (21) by a resilience force of the first spring (40).

2. The cutting structures according to claim 1, further including a supporting bracket (50), wherein the supporting bracket (50) is disposed on a side of the blade set (30), and one end of the supporting bracket (50) is connected with the first clamping handle (11) and another end of the supporting bracket (50) is extended to the second clamping handle (21), the supporting bracket (50) can provide supporting force for the first clamping handle (11) and the second clamping handle (21) when the blade set (30) perform the cutting motion.

3. The cutting structures according to claim 1, further including stripping structures (60), the stripping structures (60) are provided on one end of the first clamping seat (12) and the second clamping seat (22).

4. The cutting structures according to claim 3, wherein the stripping structures (60) include a blade seat (61) disposed on the first clamping seat (12) and a clamping set (62) disposed on the second clamping seat (22), the blade seat (61) includes a movable blade seat (611) and a fixed blade seat (612), and the clamping set (62) includes a movable clamping seat (621) and a fixed clamping seat (622).

5. The cutting structures according to claim 1, further including a plural of rivets (35), the first blade (31) and the second blade (32) are combined on the first clamping handle (11) and the second clamping handle (21) through the rivets (35).

6. The cutting structures according to claim 1, wherein the supporting bracket (50) and the first spring (40) are provided on opposite sides of the first clamping handle (11) and the second clamping handle (21).

7. The cutting structures according to claim 1, further including a second spring (70), wherein the second spring (70) and the first spring (40) are provided on opposite sides of the first clamping handle (11) and the second clamping handle (21).

8. The cutting structures according to claim 1, wherein the supporting bracket (50) is disposed between the pivot (25) and the blade set (30).

9. The cutting structures according to claim 1, wherein the supporting bracket (50) is a curved piece of body, wherein a length of the supporting bracket (50) extending over the second clamping handle (21) when the blade set (30) is in a closed status is longer than the length of the supporting bracket (50) when the blade set (30) is in an open status.

10. The cutting structures according to claim 1, wherein half of the supporting bracket (50) is connected to one side of the first clamping handle (11).
